(19) United States
(12) Patent Application Publication
(10) Pub. No.: US 2014/0292343 A1
(43) Pub. Date: Oct. 2, 2014

(54) ELECTROMAGNETIC RELAY

(71) Applicant: FUJITSU COMPONENT LIMITED, Tokyo (JP)

(72) Inventor: Masato MORIMURA, Tokyo (JP)

(73) Assignee: FUJITSU COMPONENT LIMITED, Tokyo (JP)

(21) Appl. No.: 14/226,077

(22) Filed: Mar. 26, 2014

(30) Foreign Application Priority Data
Apr. 1, 2013 (JP) 2013-076219

(51) Int. Cl. H01H 47/00; H01H 50/14; H01H 50/02

(52) U.S. Cl. CPC H01H 47/002; H01H 50/021; H01H 50/14
USPC 324/418

(57) ABSTRACT

An electromagnetic relay, includes: a housing; a contact member housed in the housing; a wiring that is housed in the housing, and is connected to the contact member; a measurement unit that is housed in the housing and inserted in the middle of the wiring, and measures a current which flows through the wiring; and a first terminal that is pulled out from the housing and is connected to the measurement unit.

### CROSS-REFERENCE TO RELATED APPLICATION

This application is based upon and claims the benefit of priority of the prior Japanese Patent Application No. 2013-076219 filed on Apr. 1, 2013, the entire contents of which are incorporated herein by reference.

### FIELD

A certain aspect of the embodiments is related to an electromagnetic relay.

### BACKGROUND

An electromagnetic relay (i.e., a relay switch) which drives a switch by an electromagnet is used for an apparatus which uses a large current, such as an in-vehicle battery and an electric power meter. In order to measure a current which flows into the electromagnetic relay, a shunt resistor may be provided in the electromagnetic relay. By measuring the current, it is detectable whether a device including the electromagnetic relay is operating appropriately. Japanese National Publication of International Patent Application No. 11-512220 discloses an electromagnetic relay that can be connected to a printed circuit board by using terminals. Japanese Examined Utility Model Application Publication No. 7-29558 discloses an art in which a terminal connected to a contact is used also as a shunt resistor for current detection. Japanese Laid-open Patent Publication No. 10-303002 discloses a unit which houses an electromagnetic relay and a terminal which functions also as the shunt resistor, into one case.

### SUMMARY

According to an aspect of the present invention, there is provided an electromagnetic relay, comprising: a housing; a contact member housed in the housing; a wiring that is housed in the housing, and is connected to the contact member; a measurement unit that is housed in the housing and inserted in the middle of the wiring, and measures a current which flows through the wiring; and a first terminal that is pulled out from the housing and is connected to the measurement unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B are views illustrating an electromagnetic relay according to a first embodiment;

FIG. 1C is a side view illustrating the electromagnetic relay;

FIG. 2 is a view illustrating the inside of the electromagnetic relay;

FIG. 3A is a side view illustrating an example of connection of the electromagnetic relay and a substrate;

FIG. 3B is a view illustrating a press-fit terminal;

FIG. 3C is a view illustrating a tab terminal;

FIG. 3D is a view illustrating a flat braided wire;

FIG. 4 is a view illustrating an electromagnetic relay according to a comparative example;

FIG. 5A is a side view illustrating an electromagnetic relay according to a second embodiment;

FIG. 5B is a side view illustrating an example of connection of the electromagnetic relay and substrates;

FIG. 6A is a view illustrating the inside of an electromagnetic relay according to a third embodiment;

FIG. 6B is a view illustrating the electromagnetic relay;

FIG. 7 is a view illustrating an electromagnetic relay according to a second comparative example; and

FIG. 8 is a view illustrating the inside of an electromagnetic relay according to a fourth embodiment.

### DESCRIPTION OF EMBODIMENTS

In the above-mentioned conventional electromagnetic relay, wiring is connected in order to measure voltage drop in the shunt resistor. When the wiring becomes long, the electromagnetic relay is enlarged. The current can also be measured by a hall element or a current transformer instead of the shunt resistor. However, the electromagnetic relay is enlarged by connecting the hall element or the current transformer to the terminal of the electromagnetic relay.

A description will now be given of embodiment of the present invention with reference to the drawings.

### First Embodiment

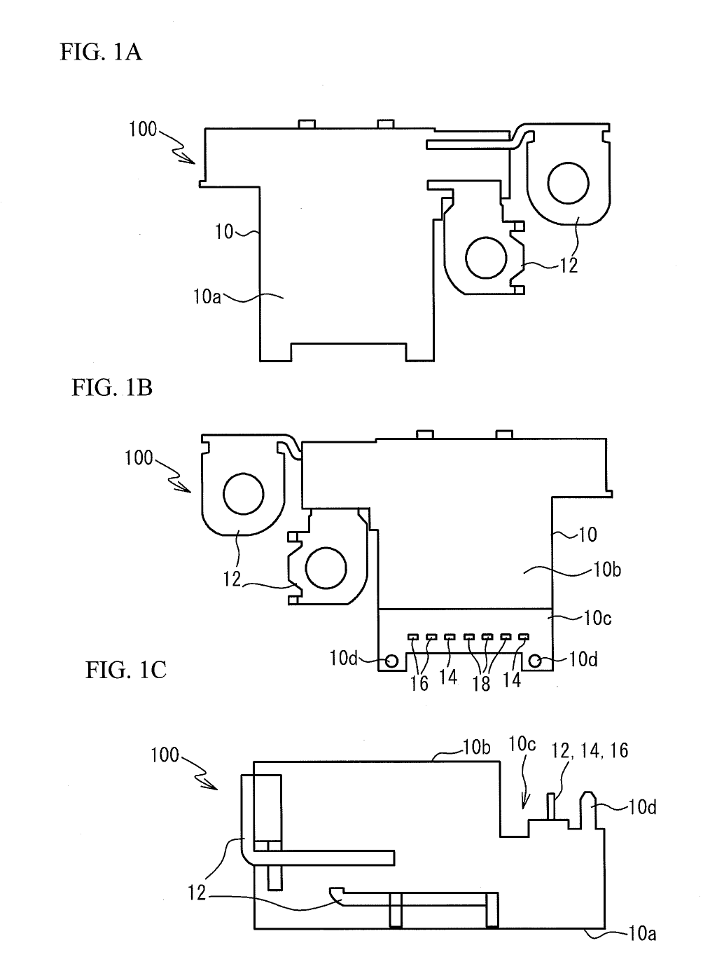

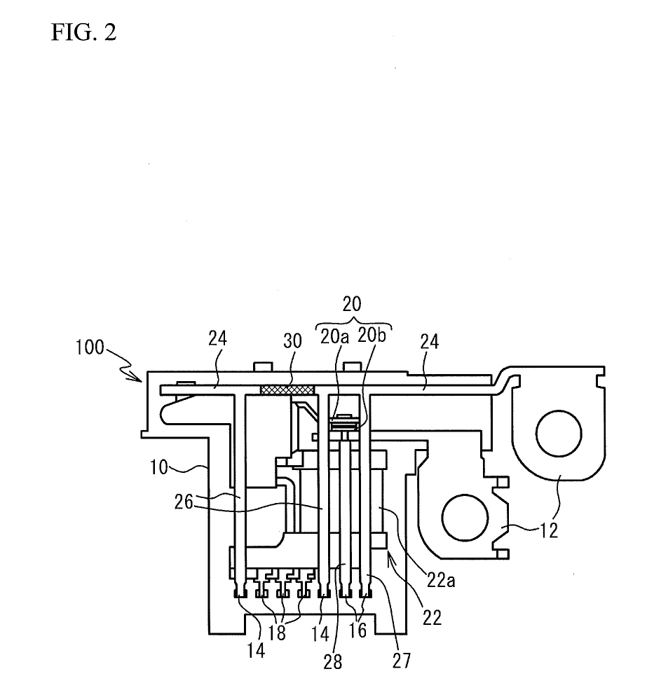

A first embodiment indicates an example in which a resistor 30 which is a shunt resistor is provided in the inside of a housing 10. FIG. 1A is a view illustrating an electromagnetic relay 100 according to a first embodiment, and illustrates a surface 10a of the housing 10. FIG. 1B is a view illustrating the electromagnetic relay 100, and illustrates a surface 10b opposite to the surface 10a. FIG. 1C is a side view illustrating the electromagnetic relay 100. FIG. 2 is a view illustrating the inside of the electromagnetic relay 100, and permeates the surface 10a.

As illustrated in FIG. 1A, the electromagnetic relay 100 includes the housing 10, and terminals 12 are pulled out from the housing 10. For example, the terminals 12 are bus bar terminals, and are used for connection between the electromagnetic relay 100 and an external device (not shown). The electromagnetic relay 100 is used for an in-vehicle battery, an electric power meter, or the like, for example, and a large current flows through the terminals 12. The electromagnetic relay 100 further includes terminals 14, 16 and 18, as illustrated in FIGS. 1B to 2. A concave unit 10c is formed on the surface 10b, as illustrated in FIGS. 1B and 1C. The terminals 14, 16 and 18, and pins 10d are provided in the concave unit 10c. The terminals 14, 16 and 18, and the pin 10d project in a direction from the surface 10a to the surface 10b (i.e., an upward direction of FIG. 1C).

As illustrated in FIG. 2, a contact member 20, an electromagnet 22, wirings 24, 26, 27 and 28, and a resistor 30 are housed inside the housing 10. The contact member 20 includes a movable contact 20a and a fixed contact 20b. The electromagnet 22 includes a coil 22a, and an iron core (not shown) which penetrates the coil 22a in an up-and-down direction of FIG. 2. The wiring 26, 27, and 28 extend from the wiring 24 across the electromagnet 22. The wiring 24 is connected to one of the two terminals 12. The wiring 27 and the two wirings 26 are electrically connected to the wiring 24, and the resistor 30 (a measurement unit) illustrated by hatching in FIG. 2 is inserted in the middle of the wiring 24. One ends of the two wirings 26 are connected to the wiring 24 so as to sandwich the resistor 30 from both sides, and another ends thereof are connected to the terminals 14 (a first terminal) One end of the wiring 27 is connected to the wiring 24, and one end of the wiring 28 is connected to the fixed contact 20b. Another ends of the wirings 27 and 28 are connected to the terminals 16 (a second terminal). The terminals 18 (a third terminal) are electrically connected to the coil 22a of the electromagnet 22. The terminals 16 detect whether the movable contact 20a comes in contact with the fixed contact 20b. The terminals 18 flow a current into the coil 22a. Here, in FIG. 2, the terminals 14, 16 and 18 project in a depth direction of a paper surface.

The operation of the electromagnetic relay 100 is explained. When the electromagnet 22 does not generate a magnetic force, the movable contact 20a is separated from the fixed contact 20b, and hence the electromagnetic relay 100 is in an OFF state. When the current is flowed into the coil 22a via the terminals 16, the electromagnet 22 generates the magnetic force. The movable contact 20a moves towards the electromagnet 22 by the magnetic force, and comes in contact with the fixed contact 20b. The electromagnetic relay 100 becomes an ON state. When the electromagnetic relay 100 becomes the ON state, the external device and the electromagnetic relay 100 are electrically conducted, and the current flows into the terminals 12 and the wiring 24.

The resistor 30 functions as the shunt resistor for measuring the current which flows into the wiring 24. Specifically, when the current flows into the wiring 24, the current also flows into the resistor 30 inserted into the wiring 24, and voltage drop arises in the resistor 30. The terminals 14 are terminals for measuring the voltage drop in the resistor 30. The current which flows into the wiring 24 can be measured by measuring the voltage drop.

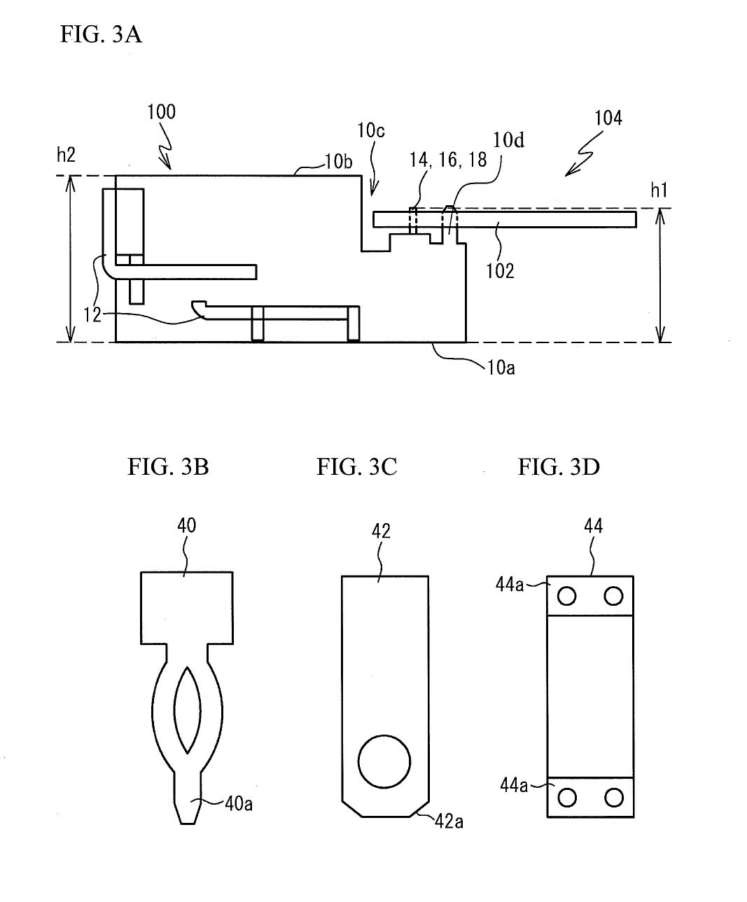

FIG. 3A is a side view illustrating an example of connection of the electromagnetic relay 100 and a substrate 102. The electromagnetic relay 100 and the substrate 102 form a unit 104. The terminals 14, 16 and 18, and the pins 10d penetrate the substrate 102. The terminals 14, 16 and 18 are electrically connected to the substrate 102. Each of the pins 10d functions as a positioning pin which decides the position of the substrate 102.

According to the first embodiment, the resistor 30 is housed in the housing 10, and the terminal 14 connected to the resistor 30 is pulled out from the housing 10. The terminal 14 connected to the resistor 30 is connectable to the substrate 102 as with the terminals 16 and 18. Thereby, it is not necessary to pull around the wiring connected to the resistor 30 to the outside of the housing 10, as with a first comparative example mentioned later. Since it is not necessary to provide a resistor and a wiring to the outside of the housing 10, the electromagnetic relay 100 can be downsized. Since the resistor 30 is inserted in the middle of the wiring 24, the housing 10 does not need to provide a space for the resistor 30. Since it is not necessary to enlarge the housing 10, the electromagnetic relay 100 can be downsized.

Since the terminals 14, 16 and 18 are pulled out in the same direction as illustrated in FIG. 3A, the single substrate 102 and the electromagnetic relay 100 can form the unit 104. The unit 104 can be downsized, compared with a case where a plurality of substrates are used. The height h1 of the terminals 14, 16, and 18 on the basis of the surface 10a of the housing 10 is lower than the height h2 of the surface 10b. Since the terminal 14 is in a position lower than the surface 10b of the housing 10, the substrate 102 connected to the terminals 14 is located between the surface 10a and the surface 10b. The unit 104 can be downsized. When the wiring provided outside the housing 10 is connected to the substrate 102, the unit including the electromagnetic relay and the substrate enlarges by only the part of length of the wiring.

Each of the terminals 14, 16 and 18 can be made into any one of a press-fit terminal 40, a tab terminal 42, and a flat braided wire 44. FIG. 3B is a view illustrating the press-fit terminal 40. The press-fit terminal is a terminal having a press-fitted shape. An apical portion 40a of the press-fit terminal 40 is turned to the substrate 102 of FIG. 3A, and is inserted into the substrate 102. FIG. 3C is a view illustrating the tab terminal 42. An apical portion 42a of the tab terminal 42 is turned to the substrate 102, and is inserted into the substrate 102. FIG. 3D is a view illustrating the flat braided wire 44. One of connection portions 44a provided on both ends of the flat braided wire 44 is connected to the substrate 102 by soldering, for example.

When the terminals 14, 16 and 18 have the same shape, the connection between the electromagnetic relay 100 and the substrate 102 becomes easy. When the terminals 14, 16 and 18 are the press-fit terminal 40 or the tab terminal 42, it is possible to connect the terminals 14, 16 and 18 to the substrate 102 at one process by inserting the terminals into holes of the substrate 102. When the terminals 14, 16 and 18 are the flat braided wire 44, it is possible to connect the terminals 14, 16 and 18 to the substrate 102 at one process by soldering a plurality of flat braided wires 44 to the substrate 102. Here, the terminals 14, 16 and 18 may have different shapes.

The wirings 26 are connected to the wiring 24 so as to sandwich the resistor 30, as illustrated in FIG. 2. The wiring 27 is connected to a position distant from the resistor 30 of the wiring 24, compared with the wirings 26. That is, each of the terminals 16 is connected to a position distant from the resistor 30, compared with each of the terminals 14. Since each of the terminals 14 is close to the resistor 30, compared with each of the terminals 16, the voltage drop can be measured with higher accuracy. The wirings 26 may be directly connected to the resistor 30, without passing the wiring 24.

The housing 10 is formed by an insulator, such as resin. The terminals 12, 14, 16 and 18 and the wirings 24, 26, 27 and 28 are formed by a metal, such as copper (Cu) or gold (Au). The resistor 30 is formed by a material which has an electrical resistor higher than the wiring 24. This is because the voltage drop becomes large and the current can be measured with sufficient accuracy. For example, the resistor 30 is formed by a metal, or an alloy containing copper such as Manganin (registered trademark). The terminals 12, 14, 16 and 18 and the wirings 24, 26, 27 and 28 are formed in an integrated fashion, for example. The layout of the wirings 26, 27 and 28 can be changed, and does not need to cross the electromagnet 22.

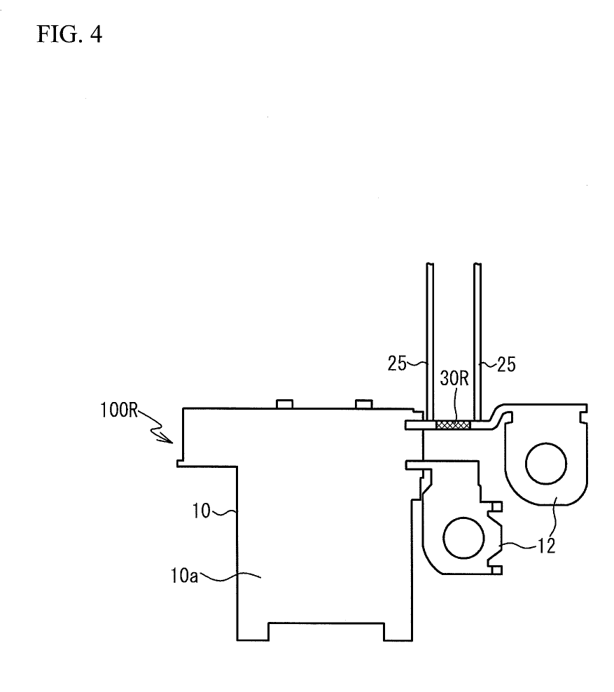

FIG. 4 is a view illustrating an electromagnetic relay 100R according to a comparative example, and illustrates the surface 10a. The illustration of the inside of the housing 10 is omitted. The electromagnetic relay 100R does not include the resistor 30 in the housing 10. A resistor 30R is formed on a part of one of the terminals 12. Two wirings 25 are connected to the one of the terminals 12 so as to sandwich the resistor 30R. The wirings 25 are connected to an ammeter or the like, not shown. Since the resistor 30R is provided outside the housing 10 and the wirings 25 are pull around outside the housing 10, it is difficult to downsize the electromagnetic relay 100R.

### Second Embodiment

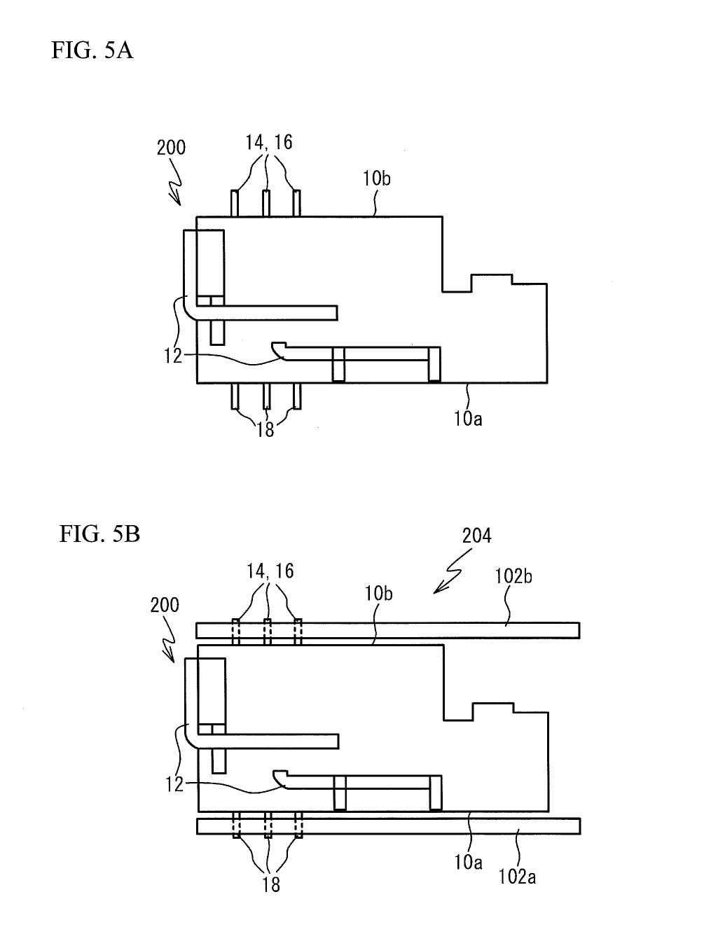

A second embodiment is an example in which the layout of the terminals 14, 16 and 18 is changed. FIG. 5A is a side view illustrating an electromagnetic relay 200 according to a second embodiment. FIG. 5B is a side view illustrating an example of connection of the electromagnetic relay 200 and substrates 102a and 102b.

As illustrated in FIGS. 5A and 5B, the terminals 18 is provided on the surface 10a, and the terminals 14 and 16 are provided on the surface 10b. The terminals 14 and 16 project upward, and the terminals 18 project downward. The terminals 14 are connected to the resistor 30 housed in the housing 10. As illustrated in FIG. 5B, the electromagnetic relay 200 and the substrates 102a and 102b form the unit 204. The substrate 102a is arranged opposite to the surface 10a, and is electrically connected to the terminals 18. The substrate 102b is arranged opposite to the surface 10b, and is electrically connected to the terminals 14 and 16.

According to the second embodiment, the electromagnetic relay 200 can be downsized as with the first embodiment. Since the terminals 14 and 16 are pulled out in a different direction from the terminals 18, the unit 204 including the two substrates 102a and 102b can be formed. Since it is not necessary to pull around the wiring, the unit 204 can be downsized. The layout of the terminals 14, 16 and 18 can be changed. When at least two of the terminals 14, 16 and 18 are pulled out in the same direction, the unit 204 can be downsized. For example, the terminals 16 and 18 may be pulled out in the same direction, and the terminals 14 may be pulled out in a direction different from the direction of the terminals 16 and 18.

### Third Embodiment

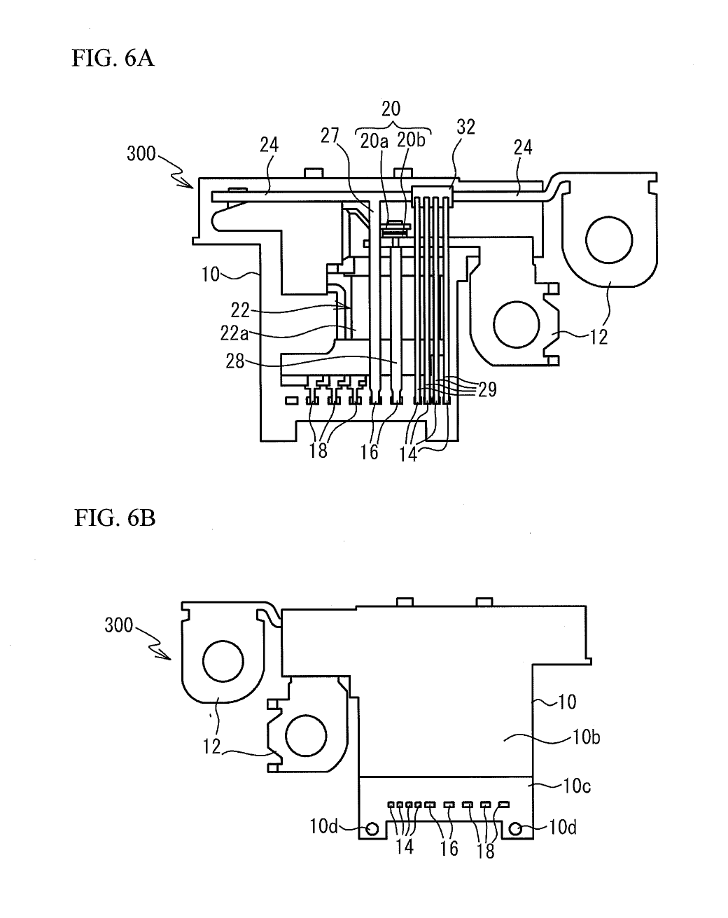

A third embodiment is an example in which a hall element 32 is used. FIG. 6A is a view illustrating the inside of an electromagnetic relay 300 according to the third embodiment. FIG. 6B is a view illustrating the electromagnetic relay 300.

As illustrated in FIG. 6A, the hall element 32 is housed inside the housing 10, and is inserted in the middle of the wiring 24. A current can be measured by the hall element 32. Four wirings 29 are connected to the hall element 32. The wirings 29 are connected to the terminals 14. As illustrated in FIG. 6B, the four terminals 14 are pulled out from the housing 10 towards the same direction as the terminals 16 and 18. According to the third embodiment, since it is not necessary to provide the hall element 32 and the wirings outside the housing 10, the electromagnetic relay 300 can be downsized.

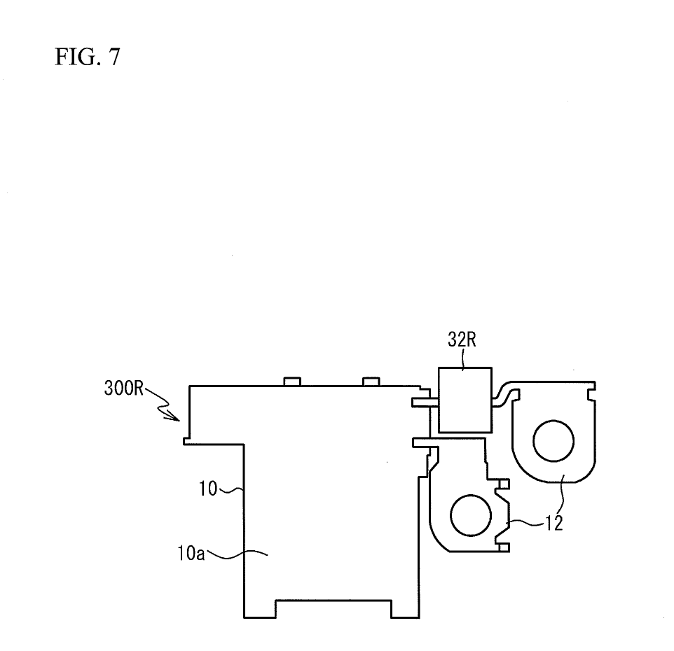

FIG. 7 is a view illustrating an electromagnetic relay 300R according to a second comparative example. In the outside of the housing 10, a hall element 32R is inserted into one of the terminals 12, as illustrated in FIG. 7. Thereby, the electromagnetic relay 300R becomes large.

### Fourth Embodiment

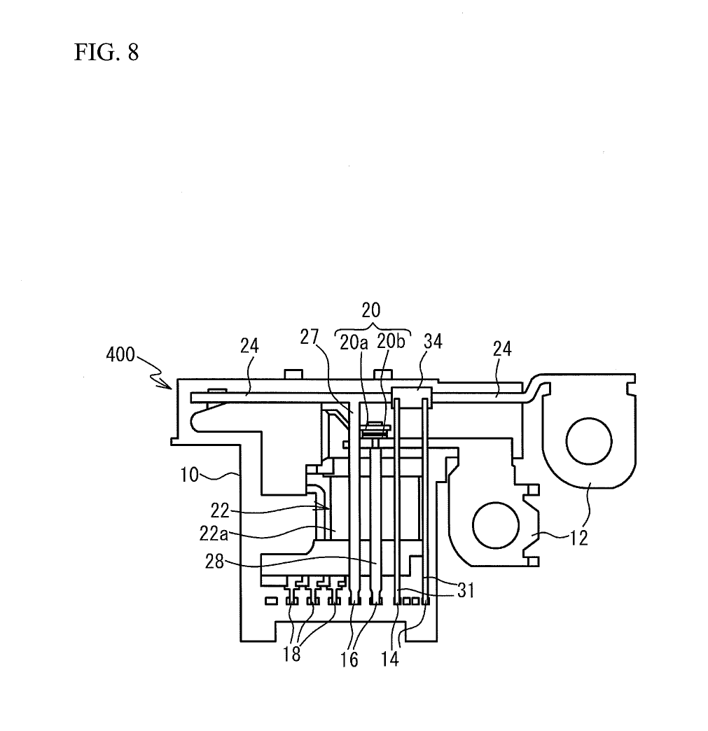

A fourth embodiment is an example in which a current transformer 34 is used. FIG. 8 is a view illustrating the inside of an electromagnetic relay 400 according to a fourth embodiment. As illustrated in FIG. 8, the current transformer 34 is housed inside the housing 10, and is inserted in the middle of the wiring 24. One ends of two wirings 31 are connected to the current transformer 34. According to the fourth embodiment, since it is not necessary to provide the current transformer 34 and the wirings outside the housing 10, the electromagnetic relay 400 can be downsized.

Since the terminals 14, 16 and 18 are pulled out in the same direction as illustrated in FIGS. 6A, 6B and 8, also in the cases of the third and the fourth embodiments, the electromagnetic relay 300 or 400 and the single substrate 102 can form the unit as with FIG. 3A. Here, as with the second embodiment, at least two of the terminals 14, 16 and 18 may be pulled out in the same direction.

An element that can measure a current other than the resistor 30, the hall element 32 and the current transformer 34 may be used as a measurement unit. When the element is housed in the housing 10, the electromagnetic relay can be downsized.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. An electromagnetic relay, comprising:
a housing;
a contact member housed in the housing;
a wiring that is housed in the housing, and is connected to the contact member;
a measurement unit that is housed in the housing and inserted in the middle of the wiring, and measures a current which flows through the wiring; and
a first terminal that is pulled out from the housing and is connected to the measurement unit.

2. The electromagnetic relay as claimed in claim 1, wherein the contact member includes a fixed contact and a movable contact,
the electromagnetic relay includes:
a second terminal that is pulled out from the housing, and is connected to the contact member;
an electromagnet that is housed in the housing, and drives the movable contact; and
a third terminal that is pulled out from the housing, and is connected to the electromagnet;
wherein at least two of the first terminal, the second terminal and the third terminal are pulled out in the same direction.

3. The electromagnetic relay as claimed in claim 2, wherein the first terminal, the second terminal and the third terminal are pulled out in the same direction.

4. The electromagnetic relay as claimed in claim 2, wherein the first terminal, the second terminal and the third terminal have the same shape.

5. The electromagnetic relay as claimed in claim 1, wherein the first terminal is in a position lower than an upper surface of the housing.

6. The electromagnetic relay as claimed in claim 1, wherein the first terminal is any one of a press-fit terminal, a tab terminal and a flat braided wire.

7. The electromagnetic relay as claimed in claim 1, wherein the measurement unit is any one of a resistor, a hall element and a current transformer.

8. The electromagnetic relay as claimed in claim 7, wherein the measurement unit is the resistor,
the second terminal is connected to a position on the wiring distant from the measurement unit, compared with the first terminal.
